(19) United States
(12) Patent Application Publication
(10) Pub. No.: US 2025/0199151 A1
(43) Pub. Date: Jun. 19, 2025

(54) HYBRID ACTIVE-PASSIVE INTELLIGENT SURFACES FOR RADAR-BASED TARGET DETECTION

(71) Applicant: Dell Products L.P., Round Rock, TX (US)

(72) Inventors: Tejinder Singh, Kanata (CA); Navjot Kaur Khaira, Kanata (CA); Davi V. Q. Rodrigues, Lubboch, TX (US)

(21) Appl. No.: 18/538,391

(22) Filed: Dec. 13, 2023

(51) Int. Cl. G01S 13/46; G01S 13/56

(52) U.S. Cl. CPC G01S 13/46; G01S 13/56; G01S 2013/462

(57) ABSTRACT

The technology described herein is directed towards a hybrid active-passive intelligent reflective surface (IRS) with configurable reflective elements to improve radar-based target detection. The elements of the IRS are configured via optimization, which determines which elements are active and which are passive, and optimizes the amplification coefficients based on an impinging signal from a radar system. Optimization increases the signal-to-noise ratio, thereby improving the radar system's ability to accurately detect objects. The optimized surface with only some elements active improves the energy efficiency, as does turning on the active elements only when assistance is needed by the radar system. Further, based on a probability of detection, the paths between the IRS and the radar system, and the IRS and a target can be controllably modified to obtain three-way communication between a moving target, an intelligent reflective surface, and the radar system, which can reduce the detection time.

### BACKGROUND

Intelligent reflective surfaces (alternatively referred to as reconfigurable intelligent surfaces, or metasurfaces) are man-made thin reflective surfaces whose electromagnetic response can be electronically controlled. Intelligent reflective surfaces thus have the ability to boost the spectral energy and spectral efficiency of redirected electromagnetic waves. Because an intelligent reflective surface can change the phase shifts of signals reflected at the surface, intelligent reflective surfaces are being evaluated for use in beyond fifth generation (B5G) and sixth generation (6G) wireless communication and wireless sensing networks.

Traditionally, wireless communication and radar systems have been realized based on a proper design and optimization of the transmitter and of the receiver, assuming that no action could be taken to improve the channel propagation characteristics. However, radar researchers have been proposing different intelligent reflective surface configurations and algorithms to improve performance of target detection, e.g., from a security viewpoint. One of the main limitations for radar-based detection is the reduced signal-to-noise ratio of the received signals. Thus, with the help of intelligent reflective surface systems, the signal-to-noise of the signals backscattered by the small targets can be improved.

Passive IRSs are nearly passive devices, which have the capability of tuning the phase, amplitude, frequency, and polarization of reflected impinging wavefronts with very low energy consumption. As such, they introduce further degrees of freedom to be exploited for system optimization and allow shaping the wireless channel impulse response. They can be mounted outdoors on building facades or in indoor environments on the ceiling or on walls. However, passive reflective surface systems cannot change amplification or beamforming of the incident signals, and thus suffer from severe path loss over multiple signal reflections. In contrast, active intelligent reflective surface systems can overcome some of the drawbacks of fully passive reflective surface systems, but consume significant power, which is not available in many limited-power scenarios.

### BRIEF DESCRIPTION OF THE DRAWINGS

The technology described herein is illustrated by way of example and not limited in the accompanying figures in which like reference numerals indicate similar elements and in which:

FIG. 1 is an example representation of radar-based detection assisted by a hybrid intelligent reflective surface, in accordance with various aspects and implementations of the subject disclosure.

FIG. 2 is an example representation of radar-based detection of a moving target assisted by a hybrid intelligent reflective surface, in accordance with various aspects and implementations of the subject disclosure.

FIG. 3 is a graphical representation of example performance of signal-to-noise ratio for a passive intelligent reflective surface, a preoptimized hybrid intelligent reflective surface and an optimized hybrid intelligent reflective surface for an indirect path versus power budgets ranging from −10 dBm to 22.5 dBm, in accordance with various aspects and implementations of the subject disclosure.

FIG. 4 is a graphical representation of example performance of signal-to-noise ratio for a passive intelligent reflective surface, a preoptimized hybrid intelligent reflective surface and an optimized hybrid intelligent reflective surface for an indirect path versus different number of elements with a fixed power budget, in accordance with various aspects and implementations of the subject disclosure.

FIG. 5 is a graphical representation of example change in signal-to-noise ratio for a passive intelligent reflective surface, a preoptimized hybrid intelligent reflective surface and an optimized hybrid intelligent reflective surface for an indirect path versus distance of the radar system to the intelligent reflective surfaces, in accordance with various aspects and implementations of the subject disclosure.

FIG. 6 is a graphical representation of example probability of detection versus radar cross section using a passive intelligent reflective surface, a preoptimized hybrid intelligent reflective surface and an optimized hybrid intelligent reflective surface, in accordance with various aspects and implementations of the subject disclosure.

FIG. 7 is a representation of an example usage scenario for a hybrid intelligent reflective surface, in accordance with various aspects and implementations of the subject disclosure.

FIG. 8 is a flow diagram showing example operations related to configuring a hybrid intelligent reflective surface based on determining passive elements and active elements, in accordance with various aspects and implementations of the subject disclosure.

FIG. 9 is a flow diagram showing example operations related to configuring a hybrid intelligent reflective surface based on a first number of active elements, a second number of passive elements, respective amplifying coefficients of the respective elements and respective reflecting coefficients of the respective elements, in accordance with various aspects and implementations of the subject disclosure.

FIG. 10 is a flow diagram showing example operations related configuring a hybrid intelligent reflective surface based on increasing a signal-to-noise ratio associated with a radar signal, including jointly optimizing variables corresponding to configurable element attributes of the reconfigurable intelligent surface, in accordance with various aspects and implementations of the subject disclosure.

### DETAILED DESCRIPTION

Various aspects of the technology described herein are generally directed towards a hybrid active-passive intelligent reflective surface topology with configurable reflective elements to improve radar-based target detection. To configure the elements of the intelligent reflective surface, including which elements are to be active elements and which are to be passive elements, an optimization algorithm is described. The optimization algorithm selects the elements and optimizes the amplification coefficients based on an impinging signal from a radar module (system). This increases the signal-to-noise ratio, which via the amplified signal returned from the intelligent reflective surface to the radar, thus improves the radar system's ability to detect object(s) in a target area. The optimized result reduces the number of active elements by selecting more optimum amplification, which improves the energy efficiency, improves the signal-to-noise ratio, and lowers the detection time while keeping the performance similar to a fully active intelligent reflective surface. Selecting the appropriate number of active elements and determining the location of those active elements overcomes the significant power consumption drawbacks of a fully active intelligent reflective surface (that has always-active elements).

Further, the probability of detection can be predetermined. Based on the probability of detection, the paths between the intelligent reflective surface and the radar system, and the intelligent reflective surface and a target can be controllably modified to reduce the detection time of surveillance drone or other moving objects. This can improve the probability of detection with the help of radar to obtain three-way communication between a moving target, an intelligent reflective surface, and radar; incorporating this aspect into the optimization algorithm can reduce the detection time.

It should be understood that any of the examples and/or descriptions herein are non-limiting. Thus, any of the embodiments, aspects, concepts, structures, functionalities or examples described herein are non-limiting, and the technology may be used in various ways that provide benefits and advantages in communications and computing in general. It also should be noted that terms used herein, such as “maximize” “optimize” or “optimal” and the like only represent objectives to move towards a more maximal or optimal state, rather than necessarily obtaining ideal results.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Further, it is to be understood that the present disclosure will be described in terms of a given illustrative architecture; however, other architectures, structures, materials and process features, and steps can be varied within the scope of the present disclosure.

Aspects of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

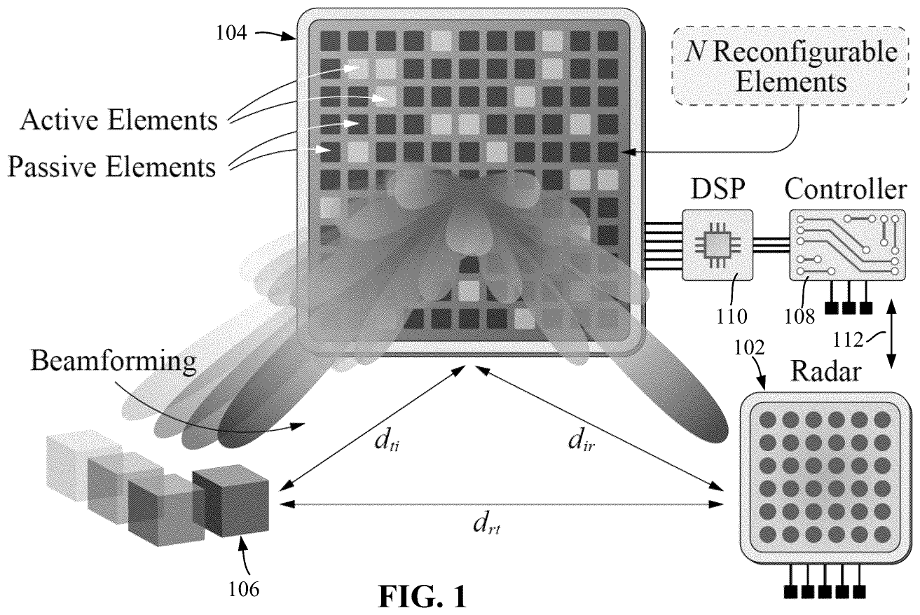

FIG. 1 shows a radar-based detection system assisted by an intelligent reflective surface 104. The radar system 102 is equipped with one transmit beam and one receive beam pointed towards a target 106 (in a target space), and one receive beam that is pointed towards the intelligent reflective surface 104, respectively. The system 102 emits a bandpass signal with bandwidth BW, carrier frequency f_{c}, and coherent processing interval T. The intelligent reflective surface 104 and the target 106 are in the far-field of the radar's antennas, and the target is placed at the far-field of the intelligent reflective surface beamformer, so the impinging signals at the intelligent reflective surface 104 and the transmitted signals at the location of the target 106 can be viewed as plane waves. For purposes of simplicity, the transmitter (transmit antenna beam) and the receiver (receive antenna beam) of the radar system 102 are assumed to be generally in the same location given the far-field plane waves.

As shown in FIG. 1, the distance between the radar system 102 and the intelligent reflective surface 104 is dᵢᵣ, the direct path distance between the radar and the target is dᵣₜ, and the distance between the target and the intelligent reflective surface 104 is dₜᵢ. The indirect path distance is thus shown as dᵢᵣ+dₜᵢ.

Current optimization strategies do not consider radar detection assisted by intelligent reflective surface (IRS) systems in scenarios with limited power available for active loads. Accordingly, in realistic scenarios, the use of fully active intelligent reflective surface systems may not be feasible due to limited power availability for the active loads. The hybrid intelligent reflective surface described herein is generally based on adding active elements to a conventional passive intelligent reflective surface (basically the same as replacing active elements from a fully active intelligent reflective surface with passive element), allowing the elements to reflect and amplify incident signals simultaneously. As a result, the hybrid intelligent reflective surface can reduce effects of double path loss and significantly improve the system performance in terms of energy efficiency detection reliability. These advantages can be attained by fully active intelligent reflective surfaces, however fully active intelligent reflective surfaces come at high cost of power consumption and hardware design, compared to the hybrid intelligent reflective surfaces with only some active elements as described herein.

Focusing on a fairness concept, a general goal is to maximize the signal-to-noise ratio (SNR) of the received signals by jointly optimizing the number of active elements, the number of passive elements, and the amplifying/reflecting coefficients. The problem is challenging compared to those with conventional passive or active IRSs, due to additional power constraints and amplified noise/interference caused by IRS active elements.

The baseband responses obtained by the receive antenna beam that is pointed towards the target (direct path) after matched-filtering and sampling is given by:

$${s}_{1} = {α}_{1} {β}_{1} + n \qquad ( 1 )$$

where α₁∈ [symbol] accounts for the target response for the direct-path, β₁=lᵣₜlₜᵣ\sqrt{PₜBWT}, Pₜ is the average power transmitted by the radar, lᵣₜ=c\sqrt{G_{R}/4π}/f_{c}dᵣₜ, lₜᵣ=c\sqrt{G_{R}}/4πf_{c}dᵣₜ, and n˜CN(0, Pₙ) represents the additive white Gaussian noise (AWGN) with zero mean and variance Pₙ.

Consider the hybrid active-passive intelligent reflective surface 104 equipped with N elements arranged as a rectangular array as in FIG. 1, where M intelligent reflective surface elements (the active elements shown as light-shaded squares in the intelligent reflective surface 104) provide positive amplification and N−M intelligent reflective surface elements (the passive elements shown as dark-shaded squares in the intelligent reflective surface 104) provide negative amplification. In contrast to other solutions, as described herein only part of the elements of the intelligent reflective surface 104 provides positive amplification gain (in log-scale) to the incident electromagnetic waves, while the remaining elements of the intelligent reflective surface 104 provide negative amplification gain. A controller 108 and digital signal processing component 110 operate to configure the configurable attributes of each element, including whether active or passive (as well as amplification coefficients and reflection coefficients as described herein).

If the n^{th} intelligent reflective surface (IRS) element is in the active mode, the corresponding complex-valued amplitude gain to the impinging signals is given by aₙe^{jθ}^{ₙ}, where aₙ∈[bₘᵢₙ, bₘₐₓ], bₘᵢₙ>1, 0≤θₙ 2π. On the other hand, if the n^{th} IRS element provides negative amplification (passive mode), then aₙ∈(0, 1) and 0≤θₙ≤2π. Define Θ=diag_{N×N}{a₁e^{jθ}^{₁}, a₂e^{jθ}^{₂}, aₙe^{jθ}^{ₙ} and ψ=diaN×N}a₁e^{jθ}^{₁}, a₂e^{jθ}^{₂}, . . . , a_{M}e^{jθ}^{_{M}}, 0, . . . 0. The target-IRS and the IRS-radar links are denoted by hₜᵢ∈ [symbol] ^{N} and hᵢᵣ∈ [symbol] ^{N}, and they can be modeled as

$${h}_{ti} = {{l}_{ti} [ {e}^{j ( {δ}_{{ti}_{1}} )} , … , {e}^{j ( {δ}_{{ti}_{n}} )} ]}^{T} and {h}_{ir} = {{l}_{ir} [ {e}^{j ( {δ}_{{ir}_{1}} )} , … , {e}^{j ( {δ}_{{ir}_{n}} )} ]}^{T} ,$$

where lₜᵢ=c\sqrt{G_{IRS}}/4πf_{c}dₜᵢ, lᵢᵣ=c\sqrt{G_{IRS}G_{R}}/4πf_{c}dᵢᵣ, δₜᵢ_{ₙ} is the phase delay along the path linking the target and the n^{th} IRS element, and δᵢᵣ_{ₙ} is the phase delay linking the n^{th} IRS element and the radar.

Likewise, the baseband responses obtained after matched filtering and sampling from the receive channel pointed towards the IRS is written as:

$${s}_{2} = {α}_{2} {β}_{2} {h}_{ir}^{H} Θ {h}_{ti} + {h}_{ir}^{H} ψ {d}_{en} + α \qquad ( 2 )$$

where α₂∈ [symbol] is the target response on the target-IRS link, β₂=lᵣₜ\sqrt{PₜBWT}, and dₑₙ˜CN(0, PₑₙI_{N}) is the dynamic effective noise introduced by the active elements of the IRS.

To formulate the problem, consider that the joint distribution of the target responses β₁˜CN(0, σ₁) and β₂˜CN(0, σ₂) are independent. The signal-to-noise ratio for the direct path and indirect path can be written as follows:

$${γ}_{1} = {k}_{1}^{2} {P}_{t} / {P}_{n} \qquad ( 3 )$$

$${γ}_{2} = \frac{{σ}_{2}^{2} {β}_{2}^{2} {\vert {h}_{ir}^{H} Θ {h}_{ti} \vert}^{2}}{{P}_{n} + {\vert {h}_{ir}^{H} ψ {d}_{en} \vert}^{2}} = \frac{{k}_{2}^{2} {{P}_{t} ( {\sum }_{n = 1}^{N} {a}_{n} )}^{2}}{( {P}_{n} + {l}_{ir}^{2} {P}_{en} {\sum }_{n = 1}^{M} {a}_{n}^{2} )} \qquad ( 4 )$$

where k₁=σ₁lᵣₜlₜᵣ\sqrt{BWT} and k₂=σ₂lᵣₜlₜᵣlᵢᵣBWT. θₙ=arg([hᵢᵣ]ₙ)−arg([hₜᵢ]ₙ), which is the optimal design for Θ.

The probability of detection for the analyzed scenario can be estimated as:

$$PD ( {γ}_{1} , {γ}_{2} ) = \frac{{γ}_{1} + 1}{( {γ}_{1} - {γ}_{2} )} {e}^{- \frac{δ}{1 + {γ}_{1}}} - \frac{{γ}_{2} + 1}{( {γ}_{1} - {γ}_{2} )} {e}^{- \frac{δ}{1 + {γ}_{2}}} . \qquad ( 5 )$$

The probability of false alarm is set to PFA=(1+δ)e^{-δ}. Because the direct-path link corresponding to (SNR₁) cannot be controlled, described herein is maximizing the probability of detection for a fixed probability of a false alarm by improving the signal-to-noise ratio (SNR) of the received signals from the indirect path (SNR₂).

Unlike other attempted solutions, various different constraints (element attribute variables) involving the number of active elements, the number of passive elements, their amplification gains, and the power allocated to the active loads are described herein.

The aforementioned optimization problem can be formulated as:

$${max}_{M , N ∈ ℕ , {a}_{n} ∈ {ℝ}_{+}} {γ}_{2} \qquad ( 6 a )$$

$${b}_{min} \leq {a}_{n} \leq {b}_{max} , if 1 \leq n \leq M \qquad ( 6 b )$$

$$0 < {a}_{n} < 1 , if M < n \leq N \qquad ( 6 c )$$

$${MP}_{DC} + ( {l}_{rt}^{2} {l}_{ti}^{2} {σ}_{2}^{2} {P}_{t} + {P}_{en} ) {\sum }_{n = 1}^{M} {a}_{n}^{2} {ξ}^{- 1} ) \leq {P}_{budget} \qquad ( 6 d )$$

where bₘᵢₙ and bₘₐₓ are the minimum and maximum amplification gains for the active loads, respectively, ξ is the amplifier efficiency for the active IRS elements, and P_{budget} is the maximum allocated for biasing of the active elements and the power of the amplified signals reflected by the active elements of the hybrid IRS.

Described herein is deriving an optimal solution for the amplification coefficients for the passive and active IRS elements without considering the power budget constraint of equation (6d). Because aₙ→0, γ₂→0, and aₙ→∞, γ₂→k₂²Pₜ(N²/M)/lᵢᵣ²Pₑₙ, there may exist coefficients aₙ, 1<n≤N, that would maximize γ₂.

The amplification coefficients for the IRS elements that operate on the passive mode only appear on the numerator of γ₂. Therefore, it can be considered that aₙ=aₘₐₓ, M<n≤N, where aₘₐₓ is the maximum negative amplification (in log-scale) provided by each passive IRS element.

On the other hand, it is appropriate to calculate the optimal number of active elements that need to be activated and their corresponding amplification coefficients. Define

$$γ ( x ) = \frac{{η ( {\sum }_{n = 1}^{M} {a}_{n} + ( N - M ) {a}_{max} )}^{2}}{( 1 + κ {\sum }_{n = 1}^{M} {a}_{n}^{2} )} ,$$

as the multivariable function that describes the behavior of γ₂ versus x=[a₁, a₂, a₃, . . . , a_{M}], x∈ [symbol] ₊^{M} where η=k₂²Pₜ/Pₙ, and κ=lᵢᵣ²Pₑₙ/Pₙ.

According to the Cauchy-Schwartz inequality,

$$γ ( x ) \leq \frac{{η ( {\sum }_{n = 1}^{M} {a}_{n} + ( N - M ) {a}_{max} )}^{2}}{( 1 + \frac{{κ ( {\sum }_{n = 1}^{M} {a}_{n} )}^{2}}{M} )} \qquad ( 7 )$$

The equality occurs if and only if the equation a₁=a₂=a₃= . . . =a_{M}=b holds. The maximization problem can be equivalently reformulated as:

$${max}_{M , N ∈ ℕ , b ∈ {ℝ}_{+}} f ( M , b ) = \frac{{η ( Mb + ( N - M ) {a}_{max} )}^{2}}{( 1 + κ {Mb}^{2} )} \qquad ( 8 a )$$

$${b}_{min} \leq b \leq {b}_{max} \qquad ( 8 b )$$

$${MP}_{DC} + ζ {Mb}^{2} \leq {P}_{budget} \qquad ( 8 c )$$

Because f(M, b) increases with M, the maximum number of active elements on the IRS is given by M*=P_{budget}/((ζb²+P_{DC}), where ζ=(lᵣₜ²lₜᵢ²σ₂²Pₜ+Pₑₙ)(ζ⁻¹. The original problem is transformed to:

$${max}_{M , N ∈ ℕ , b ∈ {ℝ}_{+}} g ( b ) = \frac{{( {Ab}^{2} + Bb + C )}^{2}}{( {xb}^{4} + {yb}^{2} + z )} \qquad ( 9 a )$$

$${b}_{min} \leq b \leq {b}_{max} \qquad ( 9 b )$$

where A=Naζ(b²+P_{budget}, B=P_{budget}, C=NaP_{DC}−aP_{budget}, x=β(β+αP_{budget}), y=2β+αP_{budget}, and z=P_{DC}². The first-order derivative of the objective function with respect to b is given by:

$${g}^{′} ( b ) = \frac{{g}_{1} ( b ) ( {Ab}^{2} + Bb + C )}{{( {xb}^{4} + {yb}^{2} + z )}^{2}} \qquad ( 10 )$$

where g₁(b)=(b⁴+Pb³+Qb+R), where P=(2xC−yA)/xB, Q=(yC−zA)/xB, and R=−z/x. The second-order polynomial (Ab²+Bb+C) have two negative roots. After analyzing the coefficients of g₁(b), it is possible to show that P·Q>0, and R<0, if P_{budget}<NP_{DC}. Therefore, there exists one positive root (b₊₊) and one negative root for g₁(b) because of Descartes's rule of signs. Since b→−∞, g₁(b)→∞, and b→∞, g₁(b)→∞, it is seen that g′(b)<0, when 0≤b<b₊₊, and g′(b)>0, when b>b₊₊. Indeed, when 0<b<b₊₊, the objective function g(b) monotonically increases with b. On the other hand, when b>b₊₊, g(b) is a decreasing function. Therefore, the maximization over γ₂ is achieved when b*=b₊₊, if bₘᵢₙ≤b₊₊≤bₘₐₓ. If b₊₊<bₘᵢₙ, b*=bₘᵢₙ. Alternatively, if bₘₐₓ<b₊₊,b*=bₘₐₓ. Consequently, M*=└P_{budget}/(ζb*²+P_{DC})┘.

In one example implementation, to further conserve IRS power, the radar system 102 can be communicatively coupled (link 112) to the IRS controller 108 so as to only turn on the IRS elements for assistance when the direct path signal-to-noise ratio at the radar is too low. For example, consider that the radar 102 detects a possible object in its target space, but with a probability based on a low SNR that is less than a threshold probability, such as fifty percent certainty. The radar 102 thus selectively requests assistance from the IRS by communicating the request to the IRS controller 108 to turn on the surface. To this end, the IRS controller 108 selectively turns on the intelligent reflective surface 104 to assist the radar 102 based on its received signal, (if any reasonable signal is indeed received at the IRS, which does not occur if there is no actual object in the target space). When some event occurs, such as a request from the radar to turn off the intelligent reflective surface 104, a timing out event, no reasonable signal (or a signal below some low threshold signal level) received at the IRS from the target space, and/or the like, the IRS controller 108 can turn off the intelligent reflective surface 104. In this way, the active elements only consume power when assistance is deemed needed by the radar 102.

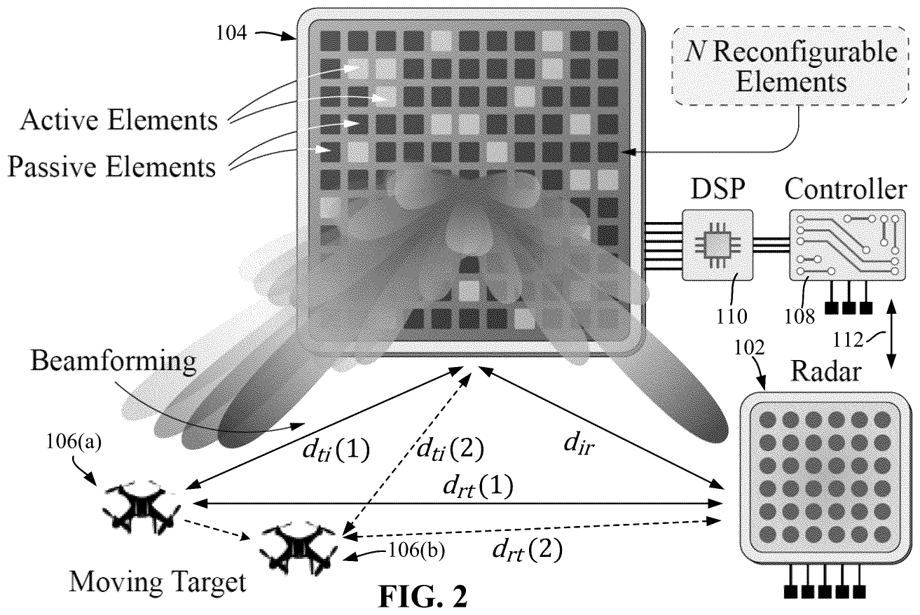

FIG. 2 shows another concept, namely reconfiguring the intelligent reflective surface 104 when a first position of a target 106(a) moves to a second position of the target 106(b), whereby, for example, the intelligent reflective surface 104 provides no useful assistance to the radar system 102. As can be seen, the indirect path distance changes from dₜᵢ(1)+dir to dₜᵢ(2)+dir. Because the radar can track velocity and position, the radar 102 can estimate a future position of the target 106(b) and request that the IRS controller 108 reconfigure (reoptimize) the elements, which will be based on the portion of the radar signal that is now being reflected to the intelligent reflective surface 104 from the new target position. In this way, the IRS system can better reflect the amplified signal to the radar 102.

Computer-generated results demonstrate the effectiveness of the technology described herein. To obtain the results, the operation frequency of the radar is set to 4 GHz, the bandwidth of the transmitted signal is 20 MHz, and the processing time is 1 ms. The gain of the receive and the transmit antennas of the radar is 30 dBi, and the gain of each element of the IRS is set to 3 dBi. The noise floor is calculated as Pₙ=−169 dBm/Hz+10 log10(W)+NF, where BW=20 MHz and NF=10 dB. The efficiency of the amplifier used by the active elements of the IRS is 0.8. The amplification gain for each active element of the IRS can vary from 10 dB (bₘᵢₙ) to 40 dB (bₘₐₓ), P_{DC}=−5 dBm and Pₑₙ=−90 dBm. The amplification gain for the passive IRS elements is fixed as −10.5 dB. The radar's output power is fixed as 1 W. For a fair comparison, the radar's output power is always adjusted to (P_{budget}+1) W for the scenario where a fully passive IRS is used.

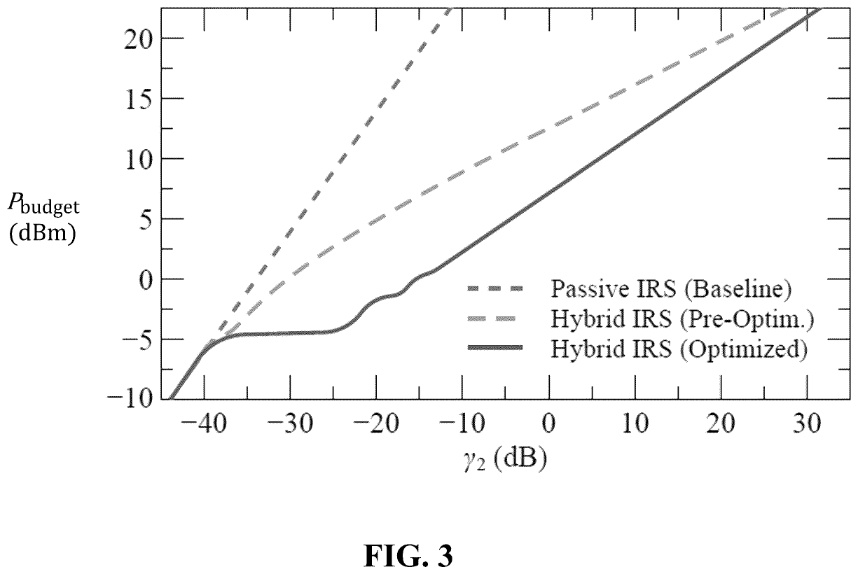

With respect to signal-to-noise ratio versus power budget, FIG. 3 shows the performances of γ₂ with change in P_{budget} of −10 dBm to 22.5 dBm, that is, shows γ₂ for an optimized hybrid IRS and a non-optimized/preoptimized (e.g., fixed gain) active-passive IRS with amplification gain fixed as 20 dB as a function of P_{budget}. Their performances are compared to the equivalent SNR provided by a fully passive IRS (N=625). The distance between the radar and the IRS was set to 500 m, the distance between the target and the IRS was set to 400 m, and the distance between the radar and the target was set to 700 m. The target's radar cross-section was set to −10 dBsm. When P_{budget}>−5 dBm, the SNR of the indirect path for a hybrid IRS is always larger than the SNR of the indirect path for a fully passive IRS. For lower values of P_{budget}, the optimized hybrid IRS offers an improvement of up to 13 dB on γ₂ as compared to the non-optimized version of the IRS. On the other hand, if P_{budget}=22.5 dBm, the SNR's improvement reduces to 4 dB. The optimized configuration offers up to 42.9 dB improvement on the SNR of the indirect-path signals as compared to a fully passive IRS P_{budget}=22.5 dBm.

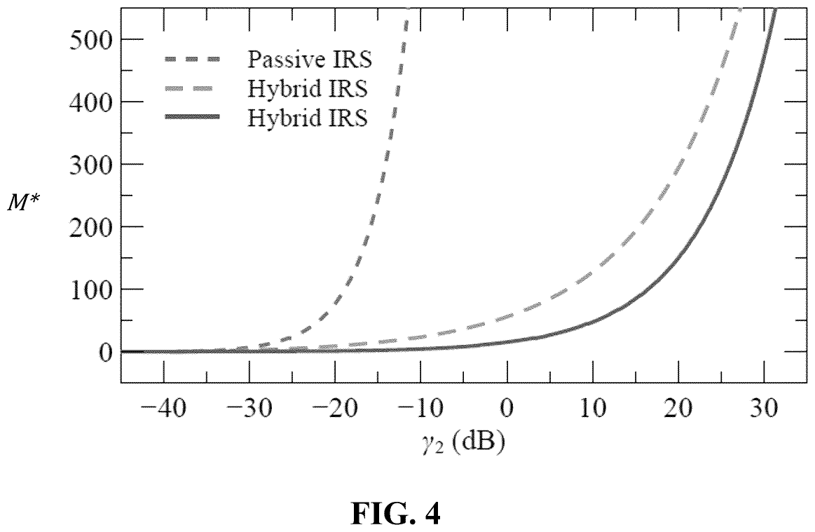

With respect to signal-to-noise ratio versus the number of active elements, FIG. 4 shows the performances of γ₂ with changes in the number of elements N with P_{budget}=17 dBm, that is, shows γ₂ versus the optimal values of M for N=625 and −10 dBm<P_{budget}<22.5 dBm. As can be seen, the measured SNR on the indirect link substantially deteriorates when P_{budget} goes below −5 dBm because of the hybrid IRS configurations. Conversely, as the power allocated to the active loads increases, the improvement on the SNR as compared to the one provided by the fully passive IRS also increases for the two reported optimized and non-optimized (preoptimized) active-passive IRS configurations. Interestingly, when the power allocated to the active IRS elements is limited, it is more advantageous to make the number of active elements as large as possible with reduced amplification gains than to make the number of active elements as small as possible with increased amplification gains.

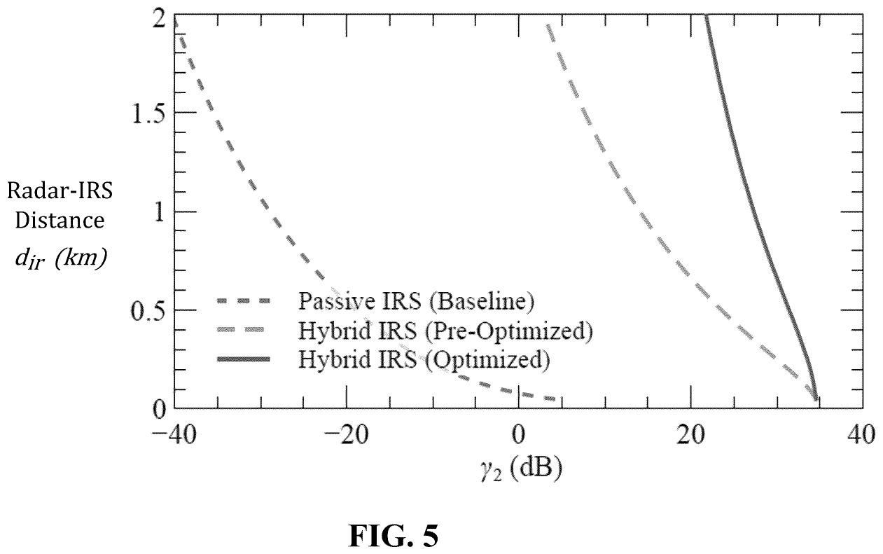

FIG. 5 is directed to indirect path SNR₂ versus the target-to-radar distance dᵢᵣ for active-passive IRS configurations compared to the SNR response by a fully passive IRS. More particularly, FIG. 5 depicts γ₂ as the radar-IRS distance changes from 50 m to 2000 m. When an optimized hybrid active-passive IRS with N=625 is used, a minimum of 30.4 dB improvement on γ₂ is observed as compared to the scenario where the radar is assisted by a fully passive IRS. In contrast, a non-optimized/preoptimized hybrid IRS with an amplification gain of 20 dB would provide equivalent SNR gain if the distance between the radar and the IRS is 50 m. However, as the distance between the radar and the IRS increases, the performance of the optimized active-passive surfaces is superior to the performance of the non-optimized version.

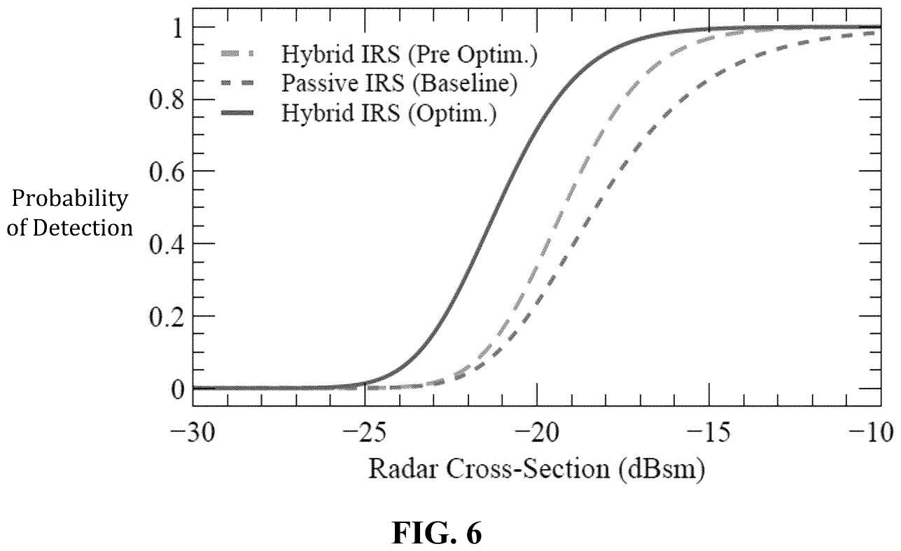

FIG. 6 is directed to an evaluation of the probability of detection using the hybrid IRS, including as optimized as described herein, that is, FIG. 6 shows a comparison of probability of detection for both the hybrid IRS cases and a baseline fully passive IRS case keeping P_{budget}=17 dBm. As can be seen, FIG. 6 exhibits the probability of detection for the optimized and non-optimized/preoptimized hybrid IRS configurations, in which the optimized and non-optimized intelligent surfaces always offer better performance than a fully passive IRS with N=625. With a fixed power budget, the optimized hybrid IRS always offers better SNR improvement than the non-optimized hybrid IRS configurations.

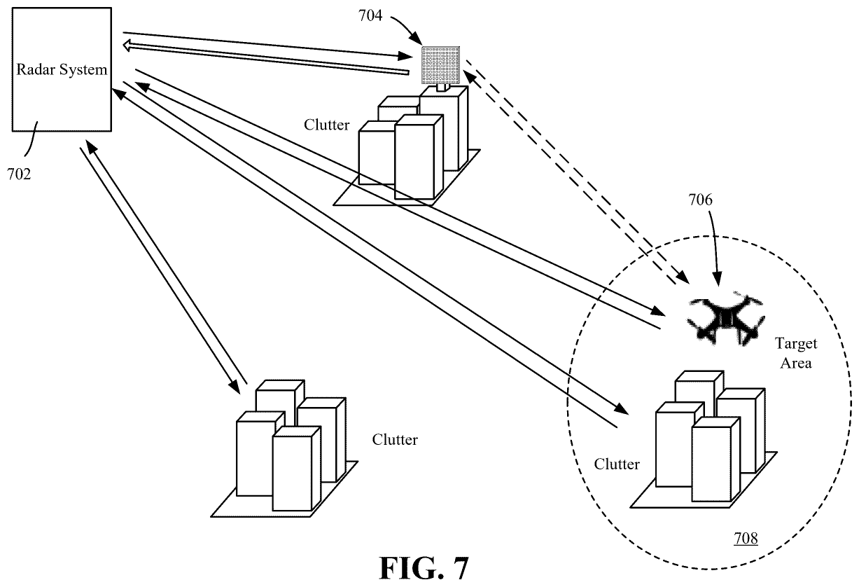

FIG. 7 depicts an example usage scenario of target 706 (unmanned aerial vehicle, or UAV) detection based on radar technology (radar system 702) as assisted by an IRS system 704 as described herein. In the example of FIG. 7, direct radar signals are shown via the solid lines, and indirect (to and from the IRS system 704) are represented via dashed lines, except that the amplified reflected signal back to the radar system 702 from the IRS system 704 is shown as a solid white arrow.

Radar systems have been the most popular choice for UAV detection due to their capability of sensing wide- and long-range area rapidly regardless of weather conditions. However, because of the movement and small sizes of many UAVs relative to clutter in the radar's targeted space, it can be difficult to accurately detect the presence of a UAV in a target area 708, which, for example, can be a restricted area. The signals via the indirect path provided by an IRS system 704 can assist in the detection. Further, the IRS can reflect the transmitted radar signals to what are otherwise shadows in the target area caused by clutter in the direct path, further enhancing target detection.

Moreover, hybrid active-passive IRS systems can be used to assist autonomous UAV navigation, and can contribute to alleviating the UAV power requirements by maximizing the power levels of the received signals from (or even the signals transmitted to) a UAV. As a result, more energy-efficient UAV autonomous navigation can be achieved. Thus, not only radar frequencies, but also beyond 5G and 6G communications can benefit from the technology described herein.

It should be noted that the sizes shown in the figures represented herein are not intended to convey any relative size or distances to any object (e.g., targets, clutter, target areas, intelligent reflective surfaces, radar systems), the components, and/or of the intelligent reflective surfaces. Indeed, the elements of the intelligent reflective surfaces in the figures are intentionally depicted as large, (e.g., considering a typical element's size relative to object representations) so that the points, angles, relative element distances and so forth can be more clearly presented.

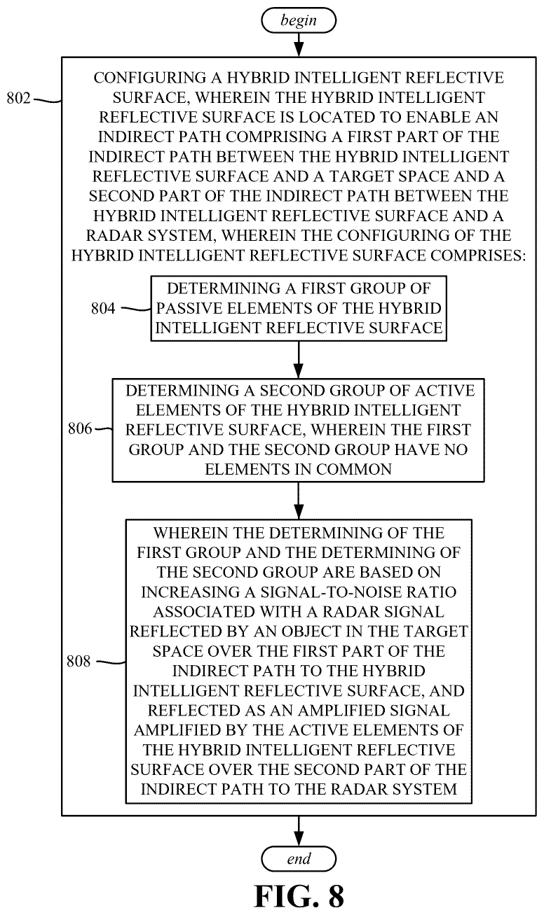

One or more aspects can be embodied in a system, such as represented in the example operations of FIG. 8, and for example can include a memory that stores computer executable components and/or operations, and a processor that executes computer executable components and/or operations stored in the memory. Example operations can include operation 802, which represents configuring a hybrid intelligent reflective surface, wherein the hybrid intelligent reflective surface is located to enable an indirect path comprising a first part of the indirect path between the hybrid intelligent reflective surface and a target space and a second part of the indirect path between the hybrid intelligent reflective surface and a radar system. Configuring the hybrid intelligent reflective surface further includes operations 804, 806 and 808. Example operation 804 represents determining a first group of passive elements of the hybrid intelligent reflective surface. Example operations 806 and 808 represent determining a second group of active elements of the hybrid intelligent reflective surface, wherein the first group and the second group have no elements in common, wherein the determining of the first group and the determining of the second group are based on increasing a signal-to-noise ratio associated with a radar signal reflected by an object in the target space over the first part of the indirect path to the hybrid intelligent reflective surface, and reflected as an amplified signal amplified by the active elements of the hybrid intelligent reflective surface over the second part of the indirect path to the radar system.

Further operations can include determining respective amplification coefficients for the active elements of the first group of active elements.

Further operations can include determining a common amplification level for the active elements of the first group of active elements.

Increasing the signal-to-noise ratio can be based on maximizing the signal-to-noise ratio.

Maximizing the signal-to-noise ratio can include jointly optimizing a first number of active elements of the first group, a second number of passive elements of the second group, amplifying coefficients of the active elements, reflecting coefficients of the active elements, and reflecting coefficients of the passive elements.

The jointly optimizing can be constrained by a power budget.

Further operations can include jointly reoptimizing to re-maximize the signal-to-noise ratio in response to an indication that the object has moved in the target space.

The jointly optimizing can be performed by a controller coupled to the hybrid intelligent reflective surface.

Increasing the signal-to-noise ratio can be based on maximizing a probability of detection for a fixed probability of a false alarm.

Further operations can include turning on the hybrid intelligent reflective surface to transmit the radar signal as was reflected as the amplified signal in response to a request from the radar system. Further operations can include turning off the hybrid intelligent reflective surface to cease transmitting the radar signal as was reflected as the amplified signal in response to an event corresponding to the radar signal no longer being requested by the radar system.

Increasing the signal-to-noise ratio can be based on determining a total number of elements of the hybrid intelligent reflective surface.

Increasing the signal-to-noise ratio can be of the signal-to-noise ratio is based on reducing a detection time of the object in the target space.

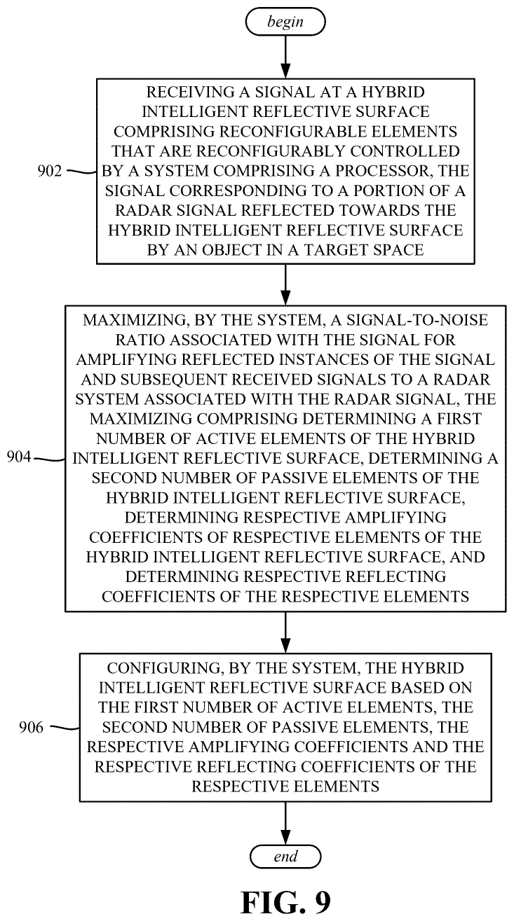

One or more example aspects, such as corresponding to example operations of a method, are represented in FIG. 9. Example operation 902 represents receiving a signal at a hybrid intelligent reflective surface comprising reconfigurable elements that are reconfigurably controlled by a system comprising a processor, the signal corresponding to a portion of a radar signal reflected towards the hybrid intelligent reflective surface by an object in a target space. Example operation 904 represents maximizing, by the system, a signal-to-noise ratio associated with the signal for amplifying reflected instances of the signal and subsequent received signals to a radar system associated with the radar signal, the maximizing comprising determining a first number of active elements of the hybrid intelligent reflective surface, determining a second number of passive elements of the hybrid intelligent reflective surface, determining respective amplifying coefficients of respective elements of the hybrid intelligent reflective surface, and determining respective reflecting coefficients of the respective elements. Example operation 906 represents configuring, by the system, the hybrid intelligent reflective surface based on the first number of active elements, the second number of passive elements, the respective amplifying coefficients and the respective reflecting coefficients of the respective elements.

Maximizing the signal-to-noise ratio can include jointly optimizing the first number of active elements, the second number of passive elements of the second group, the respective amplifying coefficients, and the respective reflecting coefficients.

The jointly optimizing can be constrained by available power.

The maximizing can be based on maximizing a probability of detection for a fixed probability of a false alarm comprising increasing the signal-to-noise ratio associated with an indirect path between the target space, the hybrid intelligent reflective surface, and a receiver of the radar system.

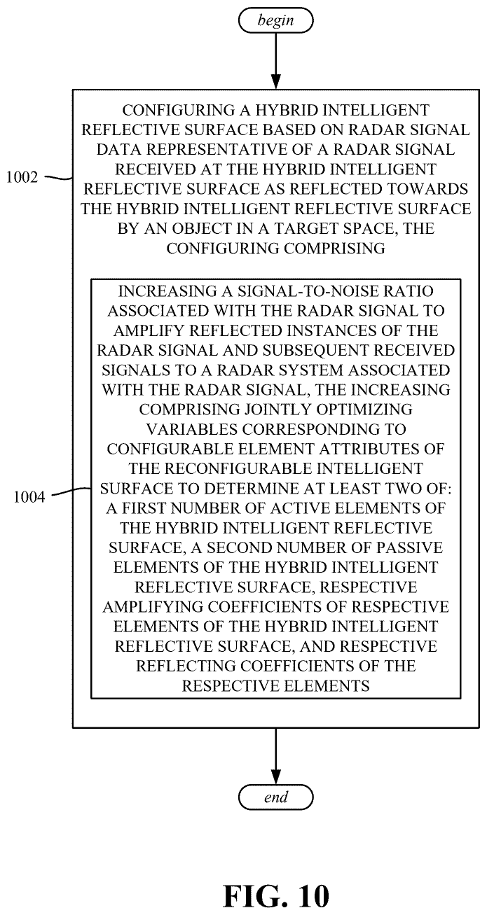

FIG. 10 summarizes various example operations, e.g., corresponding to a machine-readable medium, comprising executable instructions that, when executed by a processor, facilitate performance of operations. Example operation 1002 represents configuring a hybrid intelligent reflective surface based on radar signal data representative of a radar signal received at the hybrid intelligent reflective surface as reflected towards the hybrid intelligent reflective surface by an object in a target space. The configuring can include example operation 100, which represents increasing a signal-to-noise ratio associated with the radar signal to amplify reflected instances of the radar signal and subsequent received signals to a radar system associated with the radar signal, the increasing comprising jointly optimizing variables corresponding to configurable element attributes of the reconfigurable intelligent surface to determine at least two of: a first number of active elements of the hybrid intelligent reflective surface, a second number of passive elements of the hybrid intelligent reflective surface, respective amplifying coefficients of respective elements of the hybrid intelligent reflective surface, and respective reflecting coefficients of the respective elements.

Configuring of the hybrid intelligent reflective surface can include preselecting a total number of elements of the hybrid intelligent reflective surface.

The jointly optimizing can be based on maximizing a probability of detection for a fixed probability of a false alarm by the increasing of the signal-to-noise ratio.

As can be seen, the technology described herein assists radar detection by the use of a hybrid intelligent reflective surface. Optimization based on a received beam is used to determine which elements of the hybrid intelligent reflective surface are active and which are passive. The optimization methodology more optimally selects the amplification coefficients of active components of the hybrid IRS to enhance the power budget, which is useful for faster detection of a moving target such as a surveillance drone while keeping the power consumption of a hybrid intelligent reflective surface to a minimum or near minimum.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
configuring a hybrid intelligent reflective surface, wherein the hybrid intelligent reflective surface is located to enable an indirect path comprising a first part of the indirect path between the hybrid intelligent reflective surface and a target space and a second part of the indirect path between the hybrid intelligent reflective surface and a radar system, wherein the configuring of the hybrid intelligent reflective surface comprises:
determining a first group of passive elements of the hybrid intelligent reflective surface; and
determining a second group of active elements of the hybrid intelligent reflective surface, wherein the first group and the second group have no elements in common,
wherein the determining of the first group and the determining of the second group are based on increasing a signal-to-noise ratio associated with a radar signal reflected by an object in the target space over the first part of the indirect path to the hybrid intelligent reflective surface, and reflected as an amplified signal amplified by the active elements of the hybrid intelligent reflective surface over the second part of the indirect path to the radar system.

2. The system of claim 1, wherein the operations further comprise:
determining respective amplification coefficients for the active elements of the first group of active elements.

3. The system of claim 1, wherein the operations further comprise:
determining a common amplification level for the active elements of the first group of active elements.

4. The system of claim 1, wherein the increasing of the signal-to-noise ratio is based on maximizing the signal-to-noise ratio.

5. The system of claim 4, wherein the maximizing of the signal-to-noise ratio comprises jointly optimizing a first number of active elements of the first group, a second number of passive elements of the second group, amplifying coefficients of the active elements, reflecting coefficients of the active elements, and reflecting coefficients of the passive elements.

6. The system of claim 5, wherein the jointly optimizing is constrained by a power budget.

7. The system of claim 5, wherein the operations further comprise jointly reoptimizing to re-maximize the signal-to-noise ratio in response to an indication that the object has moved in the target space.

8. The system of claim 5, wherein the jointly optimizing is performed by a controller coupled to the hybrid intelligent reflective surface.

9. The system of claim 1, wherein the increasing of the signal-to-noise ratio is based on maximizing a probability of detection for a fixed probability of a false alarm.

10. The system of claim 1, wherein the operations further comprise:
turning on the hybrid intelligent reflective surface to transmit the radar signal as was reflected as the amplified signal in response to a request from the radar system.

11. The system of claim 10, wherein the operations further comprise:
turning off the hybrid intelligent reflective surface to cease transmitting the radar signal as was reflected as the amplified signal in response to an event corresponding to the radar signal no longer being requested by the radar system.

12. The system of claim 1, wherein the increasing of the signal-to-noise ratio is based on determining a total number of elements of the hybrid intelligent reflective surface.

13. The system of claim 1, wherein the increasing of the signal-to-noise ratio is based on reducing a detection time of the object in the target space.

14. A method comprising,
receiving a signal at a hybrid intelligent reflective surface comprising reconfigurable elements that are reconfigurably controlled by a system comprising a processor, the signal corresponding to a portion of a radar signal reflected towards the hybrid intelligent reflective surface by an object in a target space;
maximizing, by the system, a signal-to-noise ratio associated with the signal for amplifying reflected instances of the signal and subsequent received signals to a radar system associated with the radar signal, the maximizing comprising determining a first number of active elements of the hybrid intelligent reflective surface, determining a second number of passive elements of the hybrid intelligent reflective surface, determining respective amplifying coefficients of respective elements of the hybrid intelligent reflective surface, and determining respective reflecting coefficients of the respective elements; and
configuring, by the system, the hybrid intelligent reflective surface based on the first number of active elements, the second number of passive elements, the respective amplifying coefficients and the respective reflecting coefficients of the respective elements.

15. The method of claim 14, wherein the maximizing of the signal-to-noise ratio comprises jointly optimizing the first number of active elements, the second number of passive elements of the second group, the respective amplifying coefficients, and the respective reflecting coefficients.

16. The method of claim 15, wherein the jointly optimizing is constrained by available power.

17. The method of claim 14, wherein the maximizing is based on maximizing a probability of detection for a fixed probability of a false alarm comprising increasing the signal-to-noise ratio associated with an indirect path between the target space, the hybrid intelligent reflective surface, and a receiver of the radar system.

18. A non-transitory machine-readable medium, comprising executable instructions that, when executed by a processor, facilitate performance of operations, the operations comprising:
configuring a hybrid intelligent reflective surface based on radar signal data representative of a radar signal received at the hybrid intelligent reflective surface as reflected towards the hybrid intelligent reflective surface by an object in a target space, the configuring comprising:
increasing a signal-to-noise ratio associated with the radar signal to amplify reflected instances of the radar signal and subsequent received signals to a radar system associated with the radar signal, the increasing comprising jointly optimizing variables corresponding to configurable element attributes of the reconfigurable intelligent surface to determine at least two of: a first number of active elements of the hybrid intelligent reflective surface, a second number of passive elements of the hybrid intelligent reflective surface, respective amplifying coefficients of respective elements of the hybrid intelligent reflective surface, and respective reflecting coefficients of the respective elements.

19. The non-transitory machine-readable medium of claim 18, wherein the configuring of the hybrid intelligent reflective surface comprises preselecting a total number of elements of the hybrid intelligent reflective surface.

20. The non-transitory machine-readable medium of claim 18, wherein the jointly optimizing is based on maximizing a probability of detection for a fixed probability of a false alarm by the increasing of the signal-to-noise ratio.
